(19) United States
(12) Patent Application Publication
(10) Pub. No.: US 2015/0039986 A1
(43) Pub. Date: Feb. 5, 2015

(54) COLLABORATION SYSTEM AND METHOD

(71) Applicant: CollaborateNow LLC, Reston, VA (US)

(72) Inventor: Patrick A. THOMAS, Bristow, VA (US)

(21) Appl. No.: 14/447,282

(22) Filed: Jul. 30, 2014

Related U.S. Application Data
(60) Provisional application No. 61/860,557, filed on Jul. 31, 2013.

(51) Int. Cl. G06F 17/24; G06F 17/30; H04L 12/18

(52) U.S. Cl. CPC G06F 17/243; H04L 12/1822; G06F 17/30879
USPC 715/221

(57) ABSTRACT

A system to provide an environment for two or more people to collaborate on a project, share experiences, or meet new people. An administrator (which may also be a user or group moderator) can use a smart phone application or web browser to create a new group that one or more users may be a member. The administrator may use software on a computer to generate a symbol associated with this group.

### BACKGROUND

The present disclosure generally relates to a collaboration system and method. The collaboration system and method may utilize one or more smart images to enable collaboration between multiple users and provide them access to underlying information.

Typical document collaboration systems may allow multiple users to work together and collaborate on one or more documents (or files, projects, or other entities). The document collaboration system may be document-based (i.e., discussions and other notes related to the document are associated with the document instead of separated from the document). The document collaboration system may generally include software that allows the multiple users to access the document on the same platform. The document collaboration system may be a cloud-based system (or other Internet-based system) that allows the multiple users to access the documents from different locations.

A QR code is a type of barcode that may be scanned using a mobile device (e.g., such as a smartphone or other cell phone). A QR code may be associated with many different types of documents or other objects and may include information related to the document or item. For example, a QR code may appear on any object (e.g., on an advertisement in a magazine, on a sign, on a web page, etc.) and may be “scannable” by a mobile device. A user of the mobile device may be provided information by a server or mobile application (e.g., offers or discounts related to an advertised product, business information related to a QR code on a sign, a link or document related to a web page, etc.) once the QR code is scanned.

### SUMMARY

The present disclosure provides, inter alia, systems and methods for providing a software environment for two or more people to collaborate on a project, share experiences, or meet new people. In an illustrative configuration, an administrator (which may also be a user or group moderator) can use a smart phone application or web browser to create a new group. The “create new group request” can be implemented as a request to a server to generate a group (association of users) in memory. The application or browser can request the administrator enter contact information for group members. Group members may have the same rights as each other, or there may be hierarchy. The admin may also share a file (mp3, documents, picture, etc.) with the group through a URL. The admin or the server may then distribute a smart image to the group users. The smart image may be distributed through a website, made available at physical locations, emailed, faxed, sent by post on paper, etc. When a group member receives the smart image, he or she can use a scanner (such as a smart phone running an application) to read the smart image. Alternatively, the user can click on the image, if the image is distributed electronically. Both methods provide the group member with a code that the browser or application can interpret to connect to the server. For example, the browser or application may identify the group member, and indicate whether the group member wishes to join the group. The server will add the user wishing to join to the group's data or contact list. The user may then have access to all other members of that group along with their contact info (if enabled by the manager.) The server may make available the shared file to the group member if he or she joins (assuming the file isn't globally public), and request the group indicate whether he or she has viewed the file. In some cases the web browser or smart application can auto-determine whether the file has been reviewed. The server can make this group joining and file viewing status available to the admin, and/or other users. The admin may use this information to determine how many group members have accessed the invites and/or the files at any given time. An exemplary use, may be one of distributing construction bids to subcontractors. If an admin sends a request for proposal to fifty subcontractors and receives three replies, the admin may want to know whether he or she can expect to receive three bids because only three people read the request for a proposal, or whether forty contractors read it, but only three responded.

An embodiment of the present disclosure relates to a collaboration system. The system includes a first computer, a second computer, and a server, each including a processor and tangible computer readable storage media (the first computer comprising a first processor and first media, the second computer comprising a second processor and second media, and the server comprising a third processor and third media). The system may also include a form generator configured to create a form including a symbol. In one embodiment, the form generator may be configured to generate a QR code.

The first media of the first computer may include instructions that cause the first processor to receive an instruction from an administrator to generate a first account and to send a group creation request to the server. The group generation request may include group information (e.g., name and contact information, such as a phone number or email of each group member).

The third media of the server may include instructions that cause the third processor to generate the first group. The first group may include multiple tuples, each tuple including fields such as a user identifier, document attribute, joined attribute, and read attribute. The third processor may further generate a symbol including a code associated with the group creation request (e.g. a QR code). The third processor may further instruct the form generator to generate a form including the symbol.

The second media of the second computer may include instructions that cause the second processor to scan the symbol to determine the code using a program (e.g., a QR reader or scanner) associated with a first user's account. The second processor may further request the first user accept or decline an invitation to join the group and store the first user's response to the request as a first response. The second processor may further access a document specified by the document attribute of the tuple associated with the first user. The second processor may further request the first user respond whether or not the user has reviewed the document and store the first user's response as a second response. The second processor may further generate transmission to the server including the first and second response.

The third processor may identify the tuple associated with the account of the first user and mark the joined attribute and read attribute based on the first and second response. The administrator may be provided access to the group information. In one embodiment, the second media may include instructions that cause the second processor to download a program in response to a first user's response. The program may be installed into the second storage media and executed using the second processor. The first user may be provided with a choice to create a new account or log into an existing account, and with a scan function that prompts the user to scan the symbol or use a previously stored symbol.

In one embodiment, the third media may include instructions for causing the third processor to transfer the form created by the form generator to the second computer by email. The program on the second media may be configured to scan a printed version of the form or a digital version of the form. The program may further be configured to determine a list of first group members from the first group. In one embodiment, contact information for first group members may be determined via the program.

In one embodiment, the first computer readable media may include instructions to cause the first computer to generate an electronic message. A file stored locally in the first computer readable media may be attached to the electronic message, and the electronic message may be transferred to members in the first group. Alternatively or additionally, a file stored on a remote computer may be attached to the electronic message.

### BRIEF DESCRIPTION OF THE DRAWINGS

The features, aspects, and advantages of the present invention will become apparent from the following description and accompanying exemplary embodiments shown in the drawings, which are briefly described below.

FIG. 1 relates to a flow chart of a collaboration process configured to support a collaboration effort between multiple users. The collaboration processes may include processes such as managing interactions between an administrator, manager, or leader of the collaboration, a plurality of users collaborating with one another, and a server. The server may perform functions such as generating a symbol or code that may be used to access collaboration information, and managing and tracking access one or more documents or other information part of the collaboration.

FIG. 2 is a block diagram of a collaboration system that may comprise a collaboration server configured to manage interaction between the multiple users in a collaboration. The collaboration server stores collaboration information such as documents associated with the collaboration and user information for the users participating in the collaboration. Multiple user devices may communicate with the collaboration server, transmit user information to the server, and provide access to information stored at the collaboration server.

FIGS. 3A and 3B are flow charts of a collaboration process including processes such as having an administrator use a collaboration app.

FIG. 4 is a flow chart of an exemplary process for creating a collaboration group and associated symbol by an administrator.

FIG. 5 is a flow chart of an exemplary process for managing user interaction in the collaboration group (e.g., tracking if the user has accepted an invitation to the group and/or reviewed a document associated with the group).

FIG. 6 is a flow chart of an exemplary process for providing collaboration group information to an administrator of a collaboration (e.g., the information may relate to each user's interaction within the group).

FIG. 7 is a flow chart of an exemplary process for providing a user with access to a collaboration group (e.g., by providing a program executable on a user device that allows the user to scan a symbol).

FIG. 8 is a flow chart of an exemplary process for providing a messaging service for a collaboration group that allows users to communicate with one another through the collaboration server.

FIG. 9 is a block diagram of a website module, according to an exemplary embodiment. The website module may be configured to generate webpages associated with the collaboration system. Users may then interact with the collaboration system via the webpages, such as signing up for the collaboration, interacting with other users in the collaboration, managing a collaboration group, etc.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring generally to the figures, a collaboration system and method is shown and described. The collaboration system and method may allow a group of users to collaborate with one another relating to any document or other object. For example, the collaboration system and method may allow different users to collaborate with one another on the same document. As another example, the collaboration system and method may be used at a point of interest, allowing different users to provide feedback relating to the point of interest. Another user associated with the point of interest may then view and analyze the feedback.

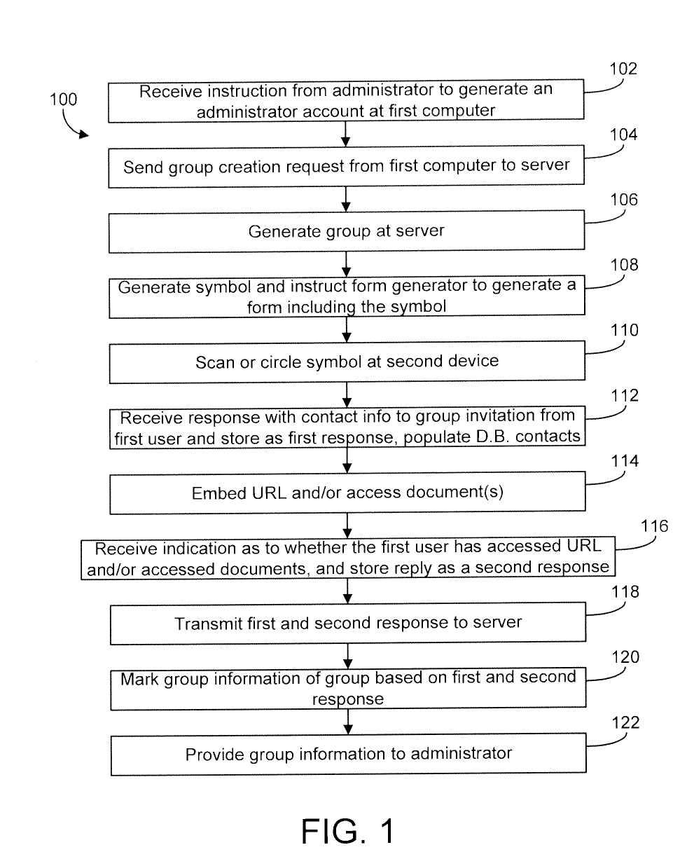

Referring to FIG. 1, a collaboration process 100 is shown and described. Process 100 may be executed by an administrator via an administrator device, one or more users via user devices, and a server configured to manage the collaboration process between a group including the administrator and one or more users.

In one embodiment, the user devices may be a remote device such as a smartphone. The remote device may include a scanner, camera, or reader configured to scan a symbol or a QR code. Upon scanning the symbol, the remote device may be configured to perform various functions related to the symbol, such as displaying text, a web page, or other information, connecting to a wireless network, retrieving documents, tracking products, and the like. In other embodiments, some of the user devices may be other types of devices that include the capability to scan symbols, or other devices that may interact with the collaboration system in other ways (e.g., via email and websites).

Process 100 is shown to include receiving instruction from an administrator to generate a first account at the first device (step 102). The administrator may be a group leader, administrator, or other user that may wish to use the collaboration process. For example, the administrator may be a group leader responsible for managing a collaboration process on a document between other group members. As another example, the administrator may be a site operator at a point of interest and may use the collaboration process to collect information about users to visit the point of interest. As another example, the administrator may be a manager of a store and may use the collaboration process to receive feedback from customers. The administrator may send a group creation request to a server via the first computer (step 104). The group creation request may include group information such as the other members of the group or criteria for visitors to be included in the group in a later step. For example, the administrator may specify a phone number or email of people to be included in the group. The administrator may create the group and group creation request via a webpage or application on the user device.

Process 100 further includes the server generating the group (step 106). Generating the group may include receiving the group information, creating multiple tuples, each tuple representing a single group member or entity, and storing the tuples in a database (D.B.). For example, each tuple may include a user identifier (identifying a single group member), a document attribute (e.g., if the group is related to a document, the document attribute may indicate user interaction with the document), a joined attribute (e.g., a user's status relating to the group), a read attribute (e.g., if the user has read a document or other information relating to the group), or other information. The server may generate a symbol including a code associated with the group creation request, and may instruct a form generator to generate a form including the symbol (step 108). For example, the server may be configured to instruct the form generator to generate a symbol for the group based on the group creation request. The symbol may be associated with the administrator. The administrator may have different symbols for different groups.

Process 100 further includes a first user scanning the symbol using a second device (step 110). In one embodiment, the symbol may be provided to the first user within a document (e.g., in the header or footer of the document). In other embodiments, the first user may scan the symbol on a physical object. The second device may include a scanner, reader, or other application configured to scan the symbol. Upon scanning the symbol, the second device may connect with a website or other online resource to determine the group to associate with the first user.

The first user may receive and respond to a group invitation, and the response may be stored as a first response by the first user device (step 112). For example, the first user may accept or decline an invitation to join the group. Such a step may further include a registration process should the first user choose to accept the invitation to the group. Alternatively, the first user may register for the group without receiving or responding to the group invitation (if they have access to the code for example.)

The first user may access a document (or other information) at the second device (step 114) and provide a response to the second device relating to if the first user reviewed (or otherwise interacted with) the document (step 116). The response may be stored as a second response by the second device. For example, the first user may read the document and provide such an indication to the second device. The second device may transmit the first and second response to the server (step 118).

Process 100 further includes the server marking group information based on the first and second response (step 120). For example, the server may mark a joined attribute of a second user of a group based on the first response and a read attribute of the first user of the group based on the second response.

The administrator may be provided with access to the first group information (step 122). For example, the administrator may view joined and read attributes of all first users in the group. In general, the administrator may control whether the first users can view each other's information, how the first users interact with each other, whether first user interaction may be subgrouped, etc. For example, the administrator may control which employees or colleagues in a group may collaborate with one another on a document, which employees may access a document or other files, if clients bidding on the same contract can view information relating to other clients, etc. The group of first users may have the ability to restrict information sharing through privacy settings. For example, a client may restrict the ability of the administrator to share his or her information with other clients.

Process 100 may be implemented in various environments. For example, the process may be used to track bids on a document. An administrator may have a document which is a contract for a project for which a group of users may submit a bid. The contract may be made available on a website via download by the administrator, and the users may access the contract via scanning a symbol. The administrator may set up a group including users that will bid on the contract. The users may receive an email or other indication from the administrator, asking the users to read the contract and bid on the contract. The users may visit the website or an application via his or her user device, and may click on or scan the symbol by using an input device of the user device or a QR scanner. If a user interacts with the symbol, the user may be taken to a webpage where the user identifies himself or herself and logs in. The user may then mark the contract as read, submit bids, and/or interact with the contract in any other way.

The administrator (and second users, if desired) may view who has logged in and interacted with the contract. In this context, the administrator may be thought of as a hub and the users as spokes. Each “spoke” may provide information to the “hub” (e.g., business information, personal information, location, etc.). The information may be stored in a database at the server, and the administrator may access the information. The administrator may provide access to other documents to a subset of the group of users. A project associated with the contract may have subprojects, and the users may provide bids on each subproject. The server may keep track of bids for the project and subprojects for the administrator. The administrator may also view if a sufficient number of views of the contract or project have occurred, ensuring that the number of bids they have received is large enough such that the bids represent close to fair market value.

As another example environment, a group of users may visit a memorial site (or any other type of point of interest). A symbol (e.g. QR code) generated by a form generator may be present at the site (e.g., on a sign at the point of interest). Instead of signing a guestbook, a group of users may scan the symbol on the sign using a smartphone or other user device to mark that they are at the point of interest. After the symbol is scanned, an application of the user device may be configured to play media (e.g., audio or video) or display text providing information about the point of interest. Further, the first user may provide comments about their experience at the point of interest. An administrator (e.g., a site operator at the point of interest) may collect information from the users, such as the time of the scan of the symbol, the type of user device used to scan the symbol, etc. The administrator may have a partnership with an advertiser and/or advertisement server, which may provide advertisements to the second users who scan the symbol via the application on the user device. The administrator may further provide information that the users provided through interaction with the symbol to the advertiser, so that the advertiser may provide content relevant to the users. The administrator may receive payment from the advertiser.

As another example environment, a group of users may scan a symbol (e.g., QR code) on a table at a restaurant via a user device. After scanning the symbol, an application on the user device may provide the users with the ability to leave comments about the service or food, view specials or menus, view restaurant information and restaurant personnel information, etc. Users may also have the ability to submit contact information and join a mailing list to receive updates, special offers, advertisements, etc. from the host (e.g. a restaurant.)

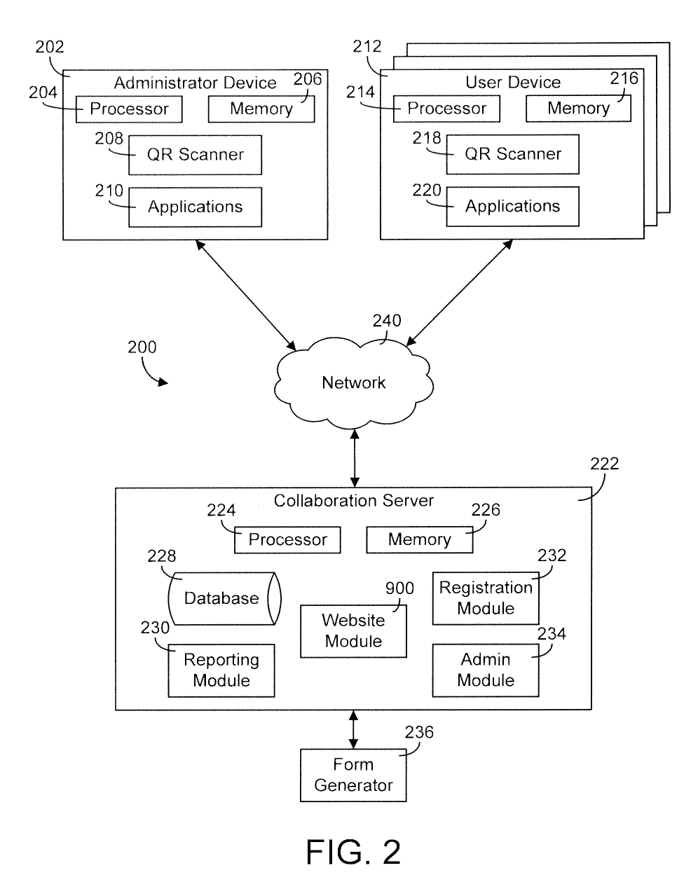

Referring to FIG. 2, a block diagram of a collaboration system 200 is shown. System 200 includes an administrator device 202, a plurality of user devices 212, and a collaboration server 222 configured to manage collaboration services between the administrator and users. The administrator device 202, plurality of user devices 212, and collaboration server 222 may each generally include a processor and memory (processors 204, 214, 224 and memories 206, 216, 226, respectively). The processor may be implemented on a chip, integrated circuit, circuit board, etc. as a general purpose processor, an application specific integrated circuit (ASIC), one or more field programmable gate arrays (FPGAs), a group of processing components, or other suitable electronic processing components. The memory is one or more devices (e.g., RAM, ROM, Flash memory, hard disk storage, etc.) for storing data and/or computer code for completing and/or facilitating the various processes described herein. Memory may be or include non-transient volatile memory or non-volatile memory or non-transitory computer readable storage media. Memory may include database components, object code components, script components, or any other type of information structure for supporting the various activities and information structures described herein. Memory may be communicably connected to the processor and includes computer code or instructions executable by the processor for executing one or more processes described herein. The administrator device 202, plurality of user devices 212, and collaboration server 222 may communicate via a network 240. The various devices and server may communicate via a wired or wireless connection.

The administrator device 202 and user devices 204 may include a scanner or reader 208, 218 configured to scan a symbol. The administrator device 202 and user devices 212 may further include one or more applications 210, 220 that may be executed on the device that allow the users to interact with the collaboration system 200. For example, upon scanning a symbol, an application 210, 220 may be executed on the device 202, 212 that allows the user to interact with the collaboration system 200 (e.g., to set up a group, to access a document or other information, to provide comments, or any other activity as described in the present disclosure). In one embodiment, the devices 202, 212 may be smartphones or other mobile devices, and the applications 210, 220 may be executable on the mobile device 202, 212. In another embodiment, one or more of the devices 202, 212 may be a laptop or desktop, and a browser application 210, 220 may provide a user with the ability to interact with the collaboration system 200 via one or more webpages.

The collaboration server 222 is shown to include a database 228 configured to store administrator and user information. For example, the database 228 may store group information for a group of users. The group information may include a tuple for each user, each tuple including a user identifier (e.g., name, phone number, email, etc.), document attribute (e.g., if a document is associated with the group, the document attribute may indicate user interaction with the document), joined attribute (e.g., the status of the user as it relates to the group), read attribute (e.g., if a user has read a document or other information related to the group), or other attributes. It should be understood that other methods of storing and organizing of data may be used in the collaboration system 200.

The collaboration server 222 is shown to include a reporting module 230 configured to provide an administrator and users with a report relating to group activity. For example, the reporting module 230 may be configured to analyze data stored in the database 228 and to generate a report for the administrator. For a group associated with a point of interest, the report may indicate how many users have visited a point of interest recently, other visitation characteristics, and other user interactions at a point of interest. The report may then be used by the administrator to improve the experience at the point of interest. For a group associated with a contract, the report may indicate which second users have accessed a document, which users have bid on a contract or will bid on a contract, which users left comments. The report may be requested by a user or generated by the collaboration server at pre-determined intervals of time.

The collaboration server 222 is shown to include a registration module 232. The registration module 232 may be configured to receive a request from an administrator to create a group, and to receive registrations from the group of users. The registration module 232 may receive a group generation request from the administrator and may store user information in the database 228. The registration module 232 may then receive a registration request from a first user and use the information in the database along with the first user input to register the first user with the group.

The collaboration server 222 is shown to include an administration module 234. The administration module 234 may be configured to allow an administrator to manage a group. For example, the administration module 234 may permit or deny user access to information based on an administrator preference. The administration module 234 may further allow the administrator to control how the users interact with one another via the collaboration system 200 (e.g., by allowing subgroups to interact with one another, by allowing one or more clients to view other bids on a contract, etc.). The administration module 234 may further be configured to manage subscriptions to the collaboration system 200. For example, an administrator may sign up for a paid service of the collaboration system 200, allowing the user to manage multiple groups.

The collaboration system 200 further includes a form generator 236 configured to generate a symbol upon request from the collaboration server 222. In various embodiments, the form generator 236 may be part of the collaboration server 222, or may be located remotely from the collaboration server 222.

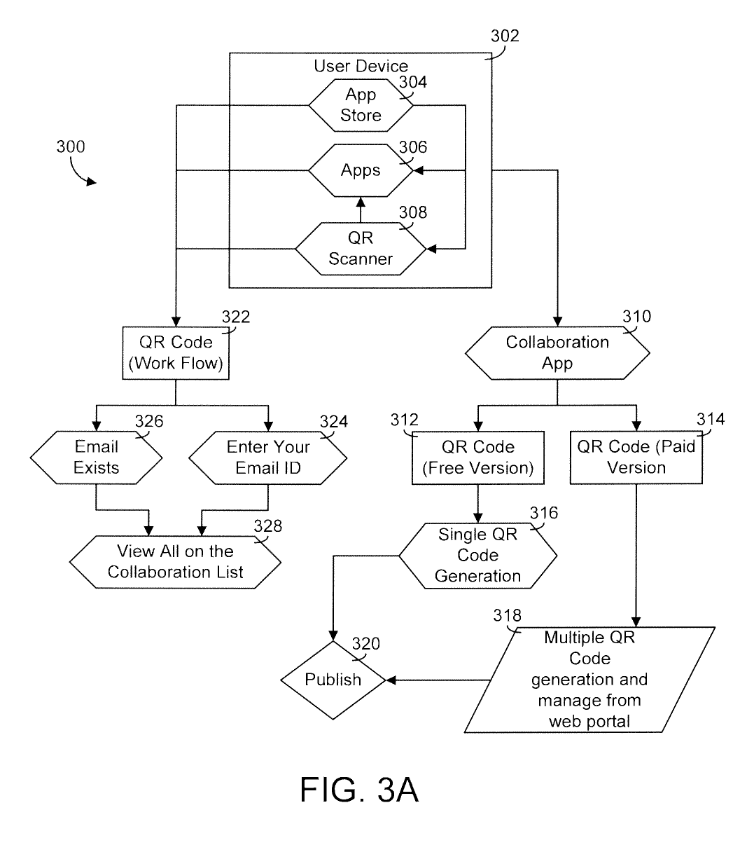

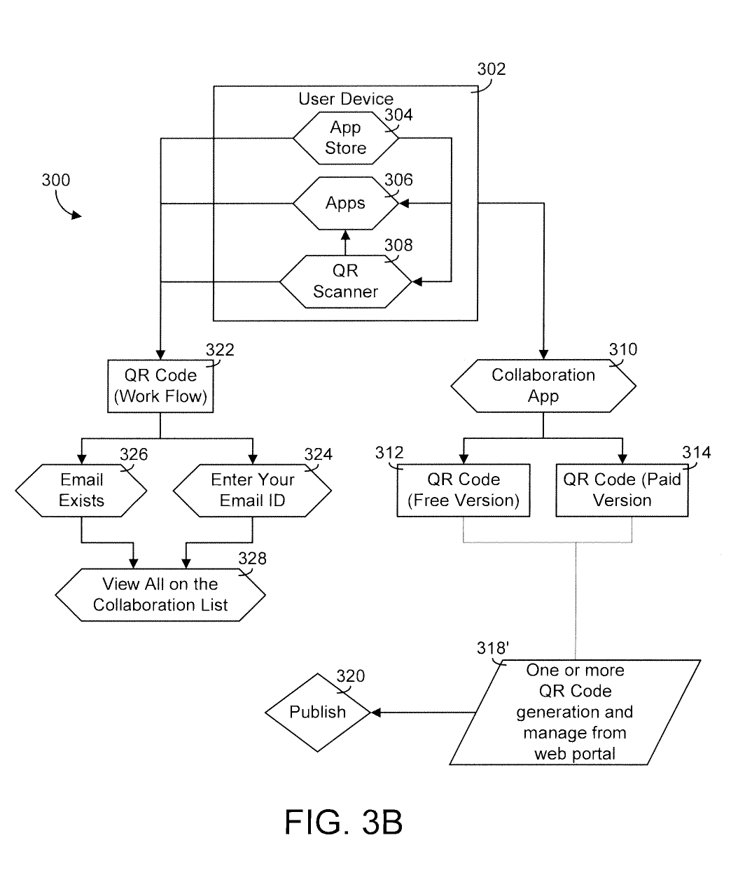

Referring to FIGS. 3A and 3B, another collaboration process 300 is shown and described. Process 300 relates to administrator and first user interaction with the collaboration system. The user device 302 of the administrator may be a smartphone or other mobile device and may include an app store 304 to access various applications and one or more downloaded applications 306 that allow the administrator to interact with the collaboration system. The mobile device may further include a QR scanner or reader 308.

The administrator may access a collaboration application 310 that allows the user to create and manage a group of users. In one embodiment, the collaboration server may allow any user to create a group, may only allow registered users to create a group, or may charge a user to create a group. The user may access a “free” version 312 or a “paid” version 314 depending on if the administrator has allowed the user to create a group. In one embodiment, the administrator may create a group (or groups in some embodiments) for free and may have a symbol generated for the free group at step 316. The free version may feature advertisements that are displayed to the first and second user. In another embodiment, the administrator may provide a payment and may have multiple symbols generated at step 318, and may be provided access to a web portal that allows the administrator to manage the groups. The group may then be published by the collaboration server at step 320. In FIG. 3B, both the free 312 and paid 314 versions of the application allow the administrator to create 318′ one or more (e.g. multiple) QR codes. In some configurations, the number of QR codes the administrator can generate will be the same for the free and paid versions of the application (only whether there are advertisements shown in the application or browser would be different), and in other configurations, the administrator will be able create more QR codes in the paid version. In other configurations, the application may feature a price-tiered structure where the number of QR codes the administrator can generate will depend on the pricing plan selected by the administrator.

The first user may access group information by scanning the symbol via the symbol scanner at step 322. The first user may have to enter an identification (e.g., email address) at step 324 if he or she has not yet registered with the group, or may be identified via the identification at step 326 is he or she has registered. The first user may then view a list of all people in the group (e.g., on the collaboration list) at step 328 and then further interact with the group as generally described in the present disclosure.

The systems and methods described herein may be adapted to allow for interaction with different media and devices. For example, the collaboration system may be configured to provide an email to allow a user to access a group instead of scanning a symbol. The email may provide a link to the user providing the user with access to the features described herein. Alternatively, the email may include the symbol (e.g., symbol that the user may scan with another user device to access the features described herein. The collaboration system may further interact with other computing devices (e.g., printers, faxes, etc.) to provide a user with information. The collaboration system may be configured to provide documents in any type of file format (e.g., pdf format, image formats, text formats, etc.).

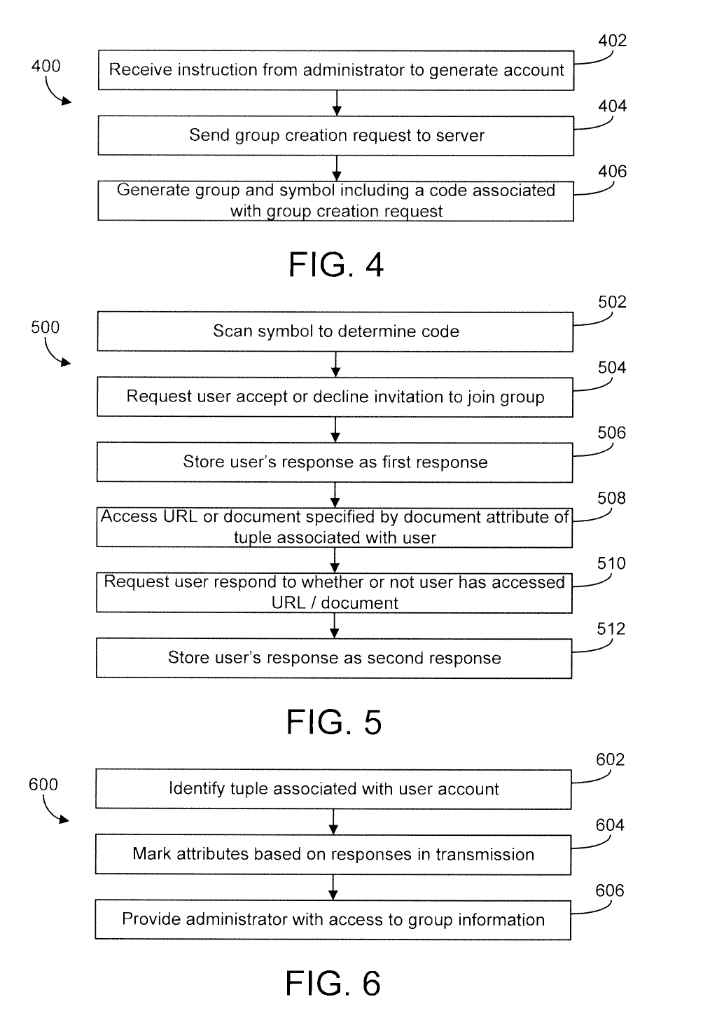

Referring generally to FIGS. 4-8, various sub-processes of the main process of FIG. 1 are described in greater detail. The processes of FIGS. 4-8 may be executed simultaneously, in parallel, or independently of one another. The processes of FIGS. 4-8 may be executed by an administrator and one or more users. The administrators and users may use one or more specially programmed computers or devices with instructions stored in tangible computer readable media to cause one or more processors in the computers or devices to execute the hereinafter described processes.

Referring to FIG. 4, a process 400 for creating a collaboration group and symbol is described. The process 400 may be executed by a collaboration server 222 and more particularly by an administration module 234 configured to manage administrator activities in a collaboration system. The process 400 includes receiving instructions from an administrator to generate an account (step 402) at an administrator device 202. Step 402 may generally include the administrator signing up for an account (either a free account or paid account). The process 400 further includes the administrator sending a group creation request to the collaboration server 222 via the administrator device 202 (step 404). The group creation request may generally include information relating to users to be invited to the group, group information, one or more documents or files associated with the group, and other information as generally described in the present disclosure. The process 400 further includes the collaboration server 222 generating the group and a symbol including a code associated with the group creation request (step 406). The code may be, for example, a QR code.

Referring to FIG. 5, a process 500 for managing user interaction in a collaboration group is described. The process 500 may be executed by a collaboration server 222 and more particularly a registration module 232 and a reporting module 230 that receive input from one or more users of the group via one or more user devices. The process 500 includes the user scanning a symbol (using a user device 212) to determine a code associated with the group (step 502). The symbol may be provided to the user via the user device 212. The symbol may be provided when an administrator or other user invites the user to a collaboration group, or may be provided after the user requests to join the group (e.g., at a landmark). The code may be a QR code, according to one embodiment.

The process 500 further includes requesting the user accept or decline an invitation to join the group (step 504). The user's response may be stored as a first response by the collaboration server 222 (step 506). The user may then access a document at the user device 212 if the user has joined the group (step 508). The document may be a document specified by a document attribute of a tuple associated with the user. For example, when the user joins a group, multiple tuples associated with the user may be generated and stored in a database 228. One tuple may be a document attribute that specifies a document associated with the user. The document is provided to the user at step 508.

The process 500 further includes requesting the user's response to whether or not the user has reviewed the document (step 510), or otherwise interacted with the document. The user's response may then be stored as a second response (step 512). The second response may be an indication the user reviewed the document, edited the document, provided comments for the document, or any other type of interaction with the document.

Referring to FIG. 6, a process 600 for providing group information to an administrator of a collaboration group is described. The process 600 may be executed by a collaboration server 222 and more particular a registration module 232 configured to provide group information to an administrator (or other users). The process 600 includes identifying a tuple associated with a user account (step 602) stored in a database 228 and marking attributes based on user responses in transmission (step 604). For example, the collaboration server 222 may receive responses indicating that various users have reviewed a document. The process 600 further includes providing an administrator with access to group information (step 606). The group information may be, for example, an indication of which users have reviewed a document, and may be provided in any format or report.

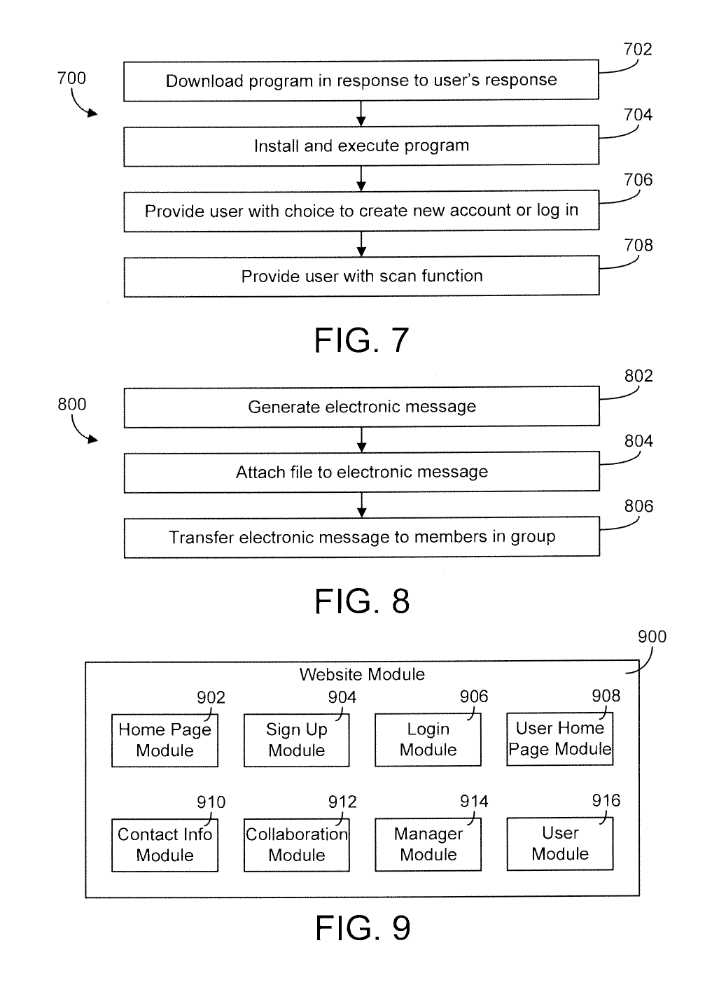

Referring to FIG. 7, a process 700 for providing a user with access to a collaboration group is described. The process 700 may be executed by a collaboration server 222 configured to provide access to a group and a user device 212 of the user. The process 700 includes the user device 212 downloading a program in response to the user's response (step 702). The user response may be an indication that the user wishes to join a collaboration group. The user device 212 installs and executes the program (step 704). The program (or application) may be provided to the user for accessing group information. The process 700 further includes providing the user with a choice to create a new account or to log in (step 706). Once the user is authenticated, the program may provide the user with a scan function (step 708) that allows the user to scan a symbol associated with the group.

Referring to FIG. 8, a process 800 for providing a messaging service for a user of the collaboration group is described. The process 800 may be executed by a collaboration server 222. The process 800 includes generating an electronic message (e.g., an email, text message, etc.) (step 802). The electronic message may be generated, for example, for an administrator creating a collaboration group. The electronic message may be a message inviting or welcoming users to the group. The process 800 further includes attaching a file to the electronic message (step 804). For example, a document associated with the group may be attached to the electronic message. The electronic message is then transferred to other users in the group (step 806). The administrator may select one or more users to transmit the message to, or all users may be sent the message.

Referring now to FIG. 9, a block diagram of a website module 900 configured to generate one or more webpages for the collaboration system and method of the present disclosure is shown. The website module 900 may be part of a collaboration server 222 as shown in FIG. 2 and/or may be a module stored in the memory of a user device 202 or 212 with instructions executed locally at the device. The website module 900 may include various sub-modules configured to generate a webpage that allows a user (e.g., administrator, first user, or second user) to interact with the collaboration system 200 as described above. For example, the website module 900 may generate a webpage that allows a user to register or login to the system, allows an administrator to manage current collaborations, allows users the ability to contact other users in the group, etc.

Webpages may be provided to the users via a browser, if the user is accessing the webpage via a laptop, desktop, etc. In other embodiments, the website module 900 may be configured to generate a display for another user application on a device. For example, a user may access the collaboration system 200 via a user app on a mobile phone, and the website module 900 may be configured to generate a display for the user app. The website module 900 may be configured to generate any type of display, for any type of user device, for the user associated with the collaboration system 200 without departing from the scope of the present disclosure.

The website module 900 includes a home page module 902. The home page module 902 may generate a webpage that may serve as a home page for a user of the collaboration system 200. The generated webpage may include various links and information that the user may access. For example, the home page may include a link that takes the user to a sign-up or register page for registering with the collaboration system. As another example, the home page may include one or more fields that allows a user to log in to the collaboration system 200. The home page may include a “forgot password” link if the user forgot his or her password and may include a “home” link that returns the user to the home page. The home page may include a “features” link that takes a user to a webpage that explains the functions and capabilities of the collaboration system 200, a “pricing” link that provides a user with pricing information related to use of the collaboration system 200, a “questions” link that provides further information, a “contact” link, “terms of use” link, “privacy policy” link, and any other link that provides a user with general information related to the collaboration system 200.

The website module 900 includes a sign-up module 904. The sign-up module 904 may generate a webpage that allows a user to register or sign-up with the collaboration system. The webpage may include one or more fields allowing a user to enter a name, username, email, mobile number, other phone number or contact information, and user password. The webpage may further include one or more fields allowing a user to associate his or her account with his or her Facebook account, LinkedIn account, or other social media account. The information may be provided to and stored at the collaboration server 222. The collaboration server 222 may then be configured to track and identify users via any of the information provided by the user. For example, the collaboration server 222 may contact the user via his or her Facebook account. LinkedIn account, text message, email, etc. regarding updates related to a collaboration process. The collaboration server 222 may require some information and not require other information, and the user may have the option to provide as much or as little contact information as possible. The collaboration server 222 may further provide the contact information to other users during the collaboration process as described above. The user may also choose privacy settings (e.g., whether the user's Facebook account or LinkedIn account should be shared with other users in a group, whether the user receives updates regarding the collaboration process, how and on which platforms the user receives updates, etc.). The user may further modify such settings after registering.

The website module 900 includes a login module 906. The login module 906 may generate a webpage that allows a user to log in to the collaboration system 200. The user may log in via an email, password, username, or any other information that identifies the user to the collaboration server 222. The user may then be redirected to the user home page or other webpage.

The website module 900 includes a user home page module 908. The user home page module 908 may generate a webpage that serves as a home page to the user. Such a webpage may include user information (e.g., contact information), current collaboration information (e.g., ongoing collaborations the user has joined), and history information (e.g., previous scans or collaborations the user has joined that are complete). The user may be presented with options to update or edit contact information, to initiate a new collaboration, to manage current collaborations the user has initiated, or to see other collaborations the user has joined. The user may select an option to be taken to a new webpage as described below.

The website module 900 includes a contact info module 910. The contact info module 910 may generate a webpage that allows a user to edit or update his or her contact information. Such a webpage may be similar in nature to the webpage provided by a sign-up module that collects user contact information.

The website module 900 includes a collaboration module 912. The collaboration module 912 may generate one or more webpages that allow a user (e.g., an administrator) to create a new collaboration. The webpage may include various fields that allow the administrator to specify various settings for the collaboration. For example, the administrator may choose a free version or paid version of the collaboration service, which may relate to a fee the user pays to create the collaboration, if advertisements will be presented to the user as a result of using the collaboration services, or otherwise. As another example, the administrator may specify a name of the collaboration or group, a host organization or group associated with the collaboration, and a description or purpose of the collaboration.

The administrator may specify what information should be collected from other users of the collaboration (e.g., name, company, work email, personal email, work phone, mobile phone, etc.). The administrators may ask for additional information such as what type of sub-contractor the user is, what type of attendee is at a conference, or other collaboration-specific information. In one embodiment, the module may provide a drop down menu or other multiple choice format, based on the type of collaboration, that allows the administrator to select an appropriate prompt to provide other users. The administrator may then use the responses to identify and understand which users fit into which group within the collaboration. The administrator may identify the number of users in a group and track and compare activities within the groups.

The webpage may further provide the administrator with various options for managing users in the collaboration. The administrator may specify which of the collected user information will be available or visible to the other users in the group (if any). The administrator may also enable or disable direct messaging between users. The administrator may upload a website or portal he or she has already built for the purposes of the collaboration. The administrator may send an inquiry to the group (e.g., an e-vite or invitation that prompts the user to RSVP or respond) and may receive the responses (e.g., a yes/no answer, a short message, etc.). The administrator may further add users or remove users in the collaboration, and may pull contact information from previous collaborations the administrator participated in for the new collaboration. The administrator may further add other users as managers or administrators for the group. A separate email or message may be generated with such an invitation to join as a manager/administrator to let them know they have been granted administration rights. The administrator may further enable a payment feature that allows managers to collect payment from the users in the collaboration. The collaboration server 222 may be configured to link with a payment processor such as Paypal, Google Checkout, etc., or a credit card processor.

After the administrator provides the necessary information, the image may be generated for the collaboration. The administrator may have the option to load a custom logo or picture to use as the image or part of the image. The collaboration module 912 may be configured to embed the image with current collaboration group information (e.g., name, information to collect, information to share with the group, web links, documents/file structures, etc.). The collaboration module 912 may generate an automated email (or other message) to send to the user list with the image. The message may include a message specified by the administrator.

The website module 900 includes a manager module 914. The manager module 914 may generate one or more webpages that allows an administrator to manage current collaborations. The administrator may be provided a list of current collaborations to select from. The list may highlight collaborations with recent activities (e.g., responses to inquiries, messages, etc.). The administrator may further be alerted with such information. The administrator may select a collaboration to be taken to a webpage that displays collaboration information such as a list of contacts. The administrator may filter the contacts alphabetically by name, company, email, or other collected information. The administrator may add or remove users from the collaboration. The collaboration server 222 may be configured to remove access to documents and to provide an alert notifying a removed user. The administrator may check for messages and other uploads from users in the collaboration, respond to the messages, send mass or individual messages to users.

The administrator may be provided a search function that allows the administrator to search through past collaborations for a user, company, or other information. The administrator may view data on user activity. For example, the administrator may view which collaborations users were invited to or participated in, and the content or document activity of the user (e.g., the number of documents accessed or downloaded, emailed, or forwarded). Such information may allow the administrator to see if a user was very active in the collaboration process. The administrator may also be provided with an option to update settings for the group of users.

The website module 916 includes a user module 916. The user module 916 may generate one or more webpages that allow a user (e.g., a non-administrator) to view information related to the collaboration. The user may view the list of group members in the collaboration, may contact specific group members through a message system provided by the webpage, may be provided contact information (email or phone) to contact specific group members externally, may respond to a question, inquiry, poll, or survey from the administrator, may make a payment to the administrator, or may leave feedback or post vendor reviews.

The collaboration server 222 and website module 900 are configured to provide various features to the collaboration process as described above. For example, the collaboration server 222 and website module 900 manages communications between users in the collaboration process. A user may have the ability to automatically compile a list of relevant contacts. A user may view and collaboration with other users directly through the application (e.g., an internal message system provided within the website) provided or via phone, email, or text message. A user may post documents and information. A user may ask questions, request feedback, respond to questions or feedback, clarify information, etc., via the application. An administrator (e.g., host, manager, etc.) may track users, manage project-specific content, etc., from one access point. Users may have the ability to invite other users to a group and add users who were missed by the administrator. The administrator may approve the users for the group before being added. Multiple users may have the ability to have manager or administrator privileges in the collaboration process. Users may leave feedback or reviews for vendors.

The collaboration server 222 and website module 900 may provide data management features for a collaboration process. An up-to-date user database with current contact information may be maintained for a collaboration process. User activity may be tracked and monitored. The user activity may be archived and previous activity history may be reviewed by a user or administrator. Such information may include which projects users were invited to or participated in, content and document activity (e.g., the number of access or downloaded documents, the number of documents forwarded or emailed, etc.), or otherwise that allows a user to see if another user was engaged in a project or accessed particular information. An administrator may add users from past projects. An archive of searchable data may be provided for an administrator. For example, the administrator may search for projects, users, companies, etc.

The collaboration server 222 and website module 900 may be configured to provide a registration and event management tool or industry conferences, trade shows, and the like. It may automatically track who has registered in advance for the event, who has arrived for the event, and may facilitate easy processing of the arrival/registration process. The event host (e.g., administrator) can access up-to-date contact information for the attendees, and can reach out to the attendees in the future or add the attendees to other events. Users may see who else is attending the event, and may contact and collaborate with them directly. The event host may embed the conference agenda, website, or other information directly into the image. Users may then access and administer directly through the collaboration server. The ability to poll attendees and solicit quick feedback may be provided before, during, or after the event, and responses may be provided directly within an application to the event host or other manager.

The collaboration server 222 and website module 900 may be configured to provide collaboration services in social applications. For example, a user may walk into a location or event and see who else is attending or at that location via an application provided by the collaboration server. The user may see if friends or contacts on Facebook, LinkedIn, or other social media sites are at the event, and may message or chat with other users via the application. The user may leave a digital signature at an event or landmark. Other users may see who else has been at the location in the past. The destination host (e.g. the host of the event, a manager of a landmark, etc.) may see who has visited, along with visitation statistics. The collaboration server may further provide a platform for local advertising to the visiting users at the event or landmark.

The collaboration server 222 and website module 900 may be configured to facilitate payment between users. The users may provide payment directly through the collaboration system. An administrator may collect payments for group activities instead of individually collecting the payments outside of the collaboration system. Administrators may then keep track of payments through the collaboration system. In one embodiment, administrators may use the collaboration system as a means for fundraising or donations, may allow for advertisements to be provided to users, or otherwise.

In one embodiment, the collaboration system 200 described herein may be provided as a pay service. For example, some services of the collaboration system 200 may be provided for free, while other services may be provided for a charge. For example, a free version of the collaboration system 200 may include advertisements, and the pay version may be ad-free. An administrator associated with a business or other large group may use a paid version of the collaboration system. The administrator may be charged per image or per collaboration, or may be charged a flat fee (e.g., flat monthly fee or other flat fee per time period).

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision step.

What is claimed is:

1. A system comprising:
a first computer comprising a first processor and a first tangible computer readable storage media;
a second computer comprising a second processor and a second tangible computer readable storage media;
a server comprising a third processor and a third tangible computer readable storage media;
a form generator configured to create a form comprising a symbol;
the first media comprising instructions for causing the first processor to:
receive an instruction from an administrator to generate a first account; and
send a group creation request from the first computer to the server, the group generation request comprising group information;
the third media comprises instructions for causing the third processor to:
generate a first group; the group information comprising group member tuples, each tuple comprising fields;
generate a symbol comprising a code associated with the group creation request; and
instruct the form generator to generate a form comprising the symbol.

2. The system of claim 1 wherein the second media comprises instructions for causing the second processor to:
scan the symbol to determine the code using a program associated with a first user's account;
request the first user accept or decline an invitation to join the first group;
store the first user's response as a first response;
access a document specified by the document attribute of the tuple associated with the first user;
request the first user respond whether or not the user has reviewed the document; store the first user's response as a second response; and
generate a transmission to the server comprising the first and second response.

3. The system of claim 1 wherein the third media comprises instructions for causing the third processor to:
identify the tuple associated with the account of the first user;
mark the joined attribute and the read attribute based on responses in the transmission; and
provide the administrator with access to the first group information.

4. The system of claim 1 wherein the second media comprises instructions for causing the second processor to:
download the program in response to a first user's response;
install the program into the second storage media;
execute the program using the second processor;
provide the first user with a choice to create a new account or log into an existing account; and
provide the first user with a scan function that prompts the user to scan the symbol or use a previously stored symbol.

5. The system of claim 1, wherein the fields comprise a user identifier, document attribute, joined attribute; and read attribute.

6. The system of claim 1 wherein the third media comprises instructions for causing the third processor to transfer the form to the second computer by email.

7. The system of claim 1 wherein the program is configured to scan a printed version of the form.

8. The system of claim 1 wherein the program is configured to scan a digital version of the form.

9. The system of claim 1 wherein the program is configured to determine a list of first group members from the first group.

10. The system of claim 9 wherein the program is configured to determine contact information for the first group members.

11. The system of claim 1 wherein the first computer readable media comprises instructions to cause the first computer to:
generate an electronic message;
attach a file stored locally in the first computer readable media to the electronic media; and
transfer the electronic message to members in the first group.

12. The system of claim 1 wherein the first computer readable media comprises instructions to cause the first computer to:
generate an electronic message;
attach a file stored on a remote computer to the electronic media; and
transfer the electronic message to members in the first group.
